(19) United States
(12) Patent Application Publication
(10) Pub. No.: US 2008/0029407 A1
(43) Pub. Date: Feb. 7, 2008

(54) Method and Electrode for The Electrochemical Removal of a Coating From a Component

(75) Inventors: Erwin Bayer, Dachau (DE); Wolfgang Eichmann, Puchheim (DE); Georgios Paronis, Augsburg (DE); Albin Platz, Ried (DE)

Correspondence Address: DAVIDSON, DAVIDSON & KAPPEL, LLC, 485 SEVENTH AVENUE, 14TH FLOOR, NEW YORK, NY, 10018, US

(73) Assignee: MTU Aero Engines GmbH, Muenchen (DE)

(21) Appl. No.: 10/590,878

(22) PCT Filed: Feb. 11, 2005
(86) PCT No.: PCT/DE05/00242

§ 371 Date: May 24, 2007

(30) Foreign Application Priority Data
Feb. 28, 2004 (DE) 10 2004 009 757.7

(51) Int. Cl. B23H 3/00

(52) U.S. Cl. 205/717

(57) ABSTRACT

A method for electrochemically stripping components, especially gas turbine components, is provided. According to the method, the component from which a coating is to be removed is connected to a positive terminal of a voltage source or current source while an electrode is connected to a negative terminal thereof. An electrode is used that is precisely adapted to a region of the component to be stripped such that a gap between the region of the component to be stripped and the electrode is approximately constant over the entire region to be stripped.

The present invention relates to a method for electrochemically stripping components, in particular gas turbine components, according to the definition of the species set forth in claim 1. The present invention also relates to an electrode for electrochemically stripping components according to the definition of the species set forth in claim 18.

To provide gas turbine components, such as rotor blades, with oxidation-resistance, corrosion-resistance or also erosion-resistance, special coatings are applied to the surfaces thereof. During operation, gas turbine components are subject to wear or can become damaged in some other way. Repairing the damage typically requires localized, partial, or also complete removal or ablation of the coating from the component to be repaired. The process of removing or ablating coatings is also described as stripping.

One distinguishes among the different stripping methods according to whether the coatings are removed mechanically, chemically or electrochemically. The present invention is directed to electrochemical stripping, which is based on the principle of electrolysis.

U.S. Pat. No. 6,165,345 describes a method for electrochemically stripping gas turbine blades. The method it describes provides for a turbine blade to be stripped to be connected to the positive terminal of a voltage source, an adapted electrode being connected to the negative terminal of the same. The electrode and at least the region of the turbine blade to be stripped are submersed into a working medium, a DC voltage of 1 to 3 V being applied for each component to produce a current flow of between 5 and 10 A. U.S. Pat. No. 6,165,345 provides that the operating range defined by the applied DC voltage used for the electrochemical stripping process be constant during the entire stripping process.

The object of the present invention is to devise a novel method for electrochemically stripping components, as well as a novel electrode for electrochemically stripping components. This objective is achieved by a method as set forth in claim 1. The present invention provides for an electrode to be used which is precisely adapted to a region of the component to be stripped in such a way that a gap between the region of the component to be stripped and the electrode is approximately the same size over the entire region to be stripped. The gap between the region of the component to be stripped and the electrode is preferably substantially constant over the entire region to be stripped and is between 10 μm and 1 mm in size.

The method according to the present invention makes possible an electrochemical stripping process in which the gaps between the electrode and the component to be stripped are extremely small, which results in an optimized current density distribution, thereby providing a selective ablation at the region of the component to be stripped. Since very small gaps are able to be maintained between the electrode and the component to be stripped, the lines of current flow take the shortest path between the electrode and the coating to be removed, so that the entire coating removal process is carried out uniformly.

One advantageous refinement of the present invention provides that the current applied or the voltage applied for the stripping process be time pulsed, the pulse frequency for the current or the voltage preferably being between 1 Hz and 10 kHz and the average amperage applied for purposes of removing coatings being between 0.1 A/mm² and 1.5 A/mm².

In accordance with another advantageous refinement of the present invention, the electrode executes a mechanical vibration in order to replace an electrolyte in this manner. In this context, a frequency of the mechanical vibration is between 1 Hz to 100 Hz, an amplitude of the mechanical vibration being between 0.1 mm and 2 mm.

Preferred uses of the method according to the present invention are defined in claims 14, 15, 16 and 17.

The electrode according to the present invention for electrochemically stripping components is claimed in claim 18.

Preferred embodiments of the present invention are derived from the dependent claims and from the following description. The present invention is described in greater detail in the following with reference to exemplary embodiments, without being limited thereto. Reference is made to the drawing, whose:

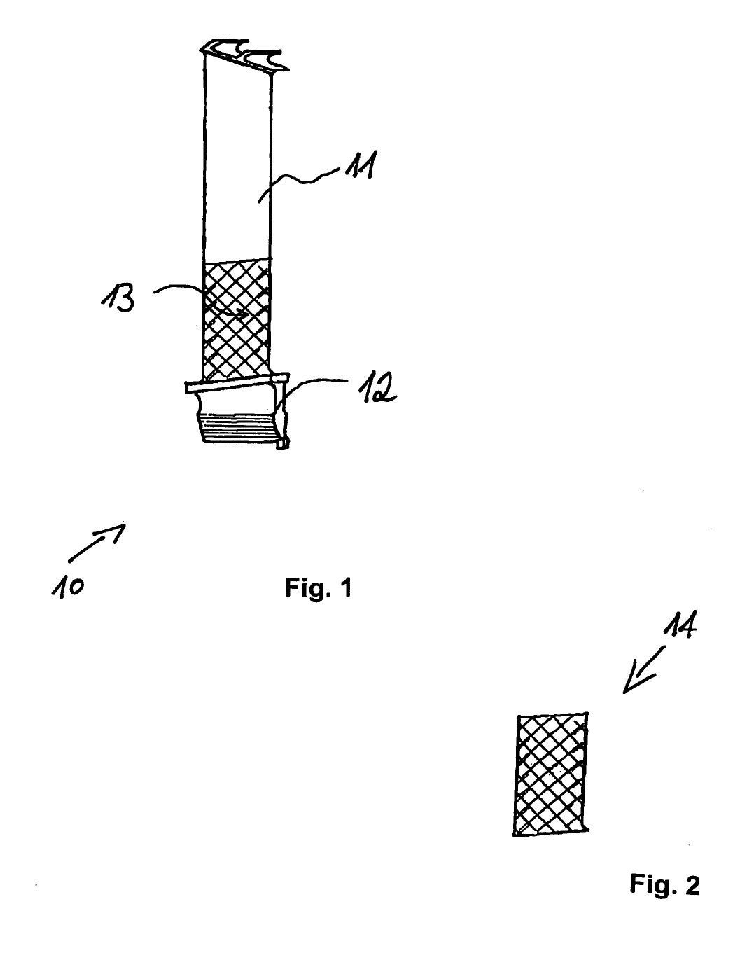

FIG. 1: shows a gas turbine blade to be stripped in a schematized representation.

The method according to the present invention is described in the following on the basis of the example of a gas turbine blade to be stripped. FIG. 1 shows such a blade 10 of a gas turbine which includes a turbine blade 11 and a blade root 12.

In the illustrated exemplary embodiment, blade 10 is provided in a region of turbine blade 11 adjacent to blade root 12 with a coating 13. This coating 13 may be an oxidation-resistant, corrosion-resistant and erosion-resistant coating.

Along the lines of the present invention, a method is provided for ablating or removing coating 13 from the surface of turbine blade 1 1 at least in some areas, in order to repair blade 10, for example. In accordance with the present invention, this is carried out electrochemically.

In order to electrochemically strip blade 10 in a specific section or region, one connects the same to a positive terminal of a voltage source or current source, while the electrode or counter electrode is connected to a negative terminal of the voltage source or current source. The electrode, as well as at least the region of blade 10 to be stripped are submersed into a working medium—into an electrolyte solution or an electrolyte.

For the electrochemical stripping process, the present invention provides for an electrode to be used which constitutes an exact reproduction of the region of the component to be stripped. A surface of the electrode facing the component to be stripped or the component region to be stripped is precisely adapted in its three-dimensional contour to the three-dimensional contour of a surface of the region to be stripped. This means that, during the process of stripping gas turbine blade 10 according to FIG. 1, when one region of turbine blade 11 is to be stripped, the three-dimensional contour of the electrode used corresponds precisely to the three-dimensional contour of the region of turbine blade 11 to be stripped. This makes it possible for a gap to be adjusted to be substantially constant between the region of the component to be stripped and the electrode, over the entire region to be stripped. It is also possible to work with very small gaps between the electrode and the component to be stripped, which results in an optimized current density distribution, thereby permitting selective coating ablation. The stripping process may be carried out at precisely or exactly defined regions without affecting adjacent or adjoining regions.

In accordance with the present invention, a gap is preferably adjusted between the region of the component to be stripped and the electrode that is approximately constant over the entire region to be stripped and is smaller than 2 mm, preferably smaller than 1 mm. In this context, the gap between the region of the component to be stripped and the electrode is preferably between 10 μm and 1 mm in size. When working with such small gaps between the component to be stripped and the electrode, the lines of current flow follow the shortest path between the electrode and the coating to be removed. The current density is independent of the component contour in the entire region to be stripped and is thus uniform, permitting an especially uniform coating removal process.

In contrast to related art methods, the present invention provides that the current applied for the stripping process or the voltage applied for the stripping process not be kept constant over time, but rather that it be time pulsed. This means that the current applied for the stripping process or the voltage applied for the stripping process is switched on and off at a specific pulse frequency. The pulse frequency is preferably between 1 Hz and 10 kHz. This enables a controlled amount of energy to be selectively introduced for the stripping process, leading to better stripping results. The average amperage applied for the stripping process is preferably between 0.1 A/mm² and 1.5 A/mm².

The parameters used for the stripping process are preferably selected in a way that prevents a passivation of the component surface to be stripped. The entire process of stripping the region from which coating is to be removed may then be implemented in one sequence of operation until complete coating removal is achieved. This reduces the processing time required for the stripping operation.

In addition, along the lines of the present invention, during the stripping process, the electrode is excited to vibrate mechanically in order to replace the electrolyte or the working medium. In this context, a frequency of the mechanical vibration is between 1 Hz to 100 Hz, an amplitude of the mechanical vibration being between 0.1 mm and 2 mm.

The stripping process is stopped or deenergized as soon as a base material of coating 13 is reached, a change in the electric potential being used as a criterion for stopping or deenergizing the stripping process. This makes it possible to prevent ablation of the base material.

The electrode used is preferably a porous electrode. The electrolyte or the working medium may be supplied or replaced through this porous electrode.

To produce the electrode, a moldable compound is used to make an impression of the region to be stripped, the compound preferably being subsequently cured. The compound is cured in air or in an oven. The moldable compound is plastically deformable and electrically conductive, so that the cured impression may be used as an electrode. The moldable compound may be made of a conductive powder and of a binding agent, wax being suited for use as a binding agent, and a brass powder, tungsten powder or copper powder as a conductive powder. When a sintered material is used as a moldable compound, a porous electrode is able to be produced very easily in the manner described above. When a soldering tin is used as a moldable compound, for example, the need for curing is eliminated.

The method according to the present invention is especially suited for use in the stripping of gas turbine blades, namely for removing or for ablating coatings which protect against oxidation, corrosion or also erosion. The method according to the present invention is also suited for removing so-called adhesion layers, which are located between the component and the actual antiwear coating and whose material composition is similar to that of the actual component. Thus, the method according to the present invention makes it possible to selectively remove an adhesion layer of titanium nitrite from a component made of titanium or of a titanium-based alloy, without adversely affecting the actual component. Under related-art stripping methods, metallic components are only able to be stripped of coatings having similar compositions to a less than satisfactory extent.

Accordingly, the method according to the present invention makes possible a selective and thus precise electrochemical stripping of components. Therefore, the method according to the present invention may also be described as a PECM (precise electrochemical machining) method. Accordingly, the important advantages of the method according to the present invention are: Coatings are able to be removed whose composition is similar to the base material of the component to be stripped; coatings disposed on complex component geometries are able to be removed in a process that achieves contour accuracy; passivation of the component surface to be processed is avoided during the stripping process; a very uniform and thus rapid stripping of components is possible.

1-19. (canceled)

20. A method for electrochemically stripping components comprising the steps of:
connecting a component to be stripped to a positive terminal of a voltage or current source and an electrode to a negative terminal of the voltage or current source;
positioning the electrode so that a gap between a region of the component to be stripped and the electrode is a same size over an entirety of the region to be stripped, the electrode being adapted to a region of the component to be stripped; and
electrochemically stripping the component.

21. The method as recited in claim 20 wherein a surface of the electrode facing the component to be stripped is precisely adapted in an electrode three-dimensional contour to a component three-dimensional contour of a surface of the region to be stripped.

22. The method as recited in claim 20 wherein the gap between the region of the component to be stripped and the electrode is smaller than 2 mm over the entirety of the region to be stripped.

23. The method as recited in claim 22 wherein the gap between the region of the component to be stripped and the electrode is smaller than 1 mm over the entirety of the region to be stripped.

24. The method as recited in claim 22 wherein the gap between the region of the component to be stripped and the electrode is constant over the entirety of the region to be stripped and is between 10 μm and 1 mm in size.

25. The method as recited in claim 20 wherein the electrode executes a mechanical vibration to replace an electrolyte.

26. The method as recited in claim 25 wherein a frequency of the mechanical vibration is between 1 Hz to 100 Hz, and an amplitude of the mechanical vibration is between 0.1 mm and 2 mm.

27. The method as recited in claim 20 wherein the electrode is a porous electrode, and further comprising supplying or replacing an electrolyte through the electrode.

28. The method as recited in claim 20 wherein the current or the voltage applied for the stripping process is time pulsed.

29. The method as recited in claim 28 wherein a pulse frequency for the current or the voltage is between 1 Hz and 10 kHz.

30. The method as recited in claim 28 wherein an average amperage applied for the stripping process is between 0.1 A/mm² and 1.5 A/mm².

31. The method as recited in claim 20 wherein process parameters used for the stripping are selected to prevent a passivation of the region to be stripped, so that an entirety of stripping a coating from the region of the component is capable of being implemented in one sequence of operation until complete removal of the coating is achieved.

32. The method as recited in claim 20 further comprising stopping or deenergizing the stripping as a function of a change in an electric potential.

33. The method as recited in claim 20 wherein the component is a gas turbine component.

34. The method as recited in claim 33 wherein the stripping is at least part of a step of repairing the gas turbine component.

35. The method as recited in claim 33 wherein the gas turbine blade is made of a titanium-based alloy or of a nickel-based alloy.

36. The method as recited in claim 20 wherein the stripping includes removing a metallic coating from the component, the component being a gas turbine component, the metallic coating to be removed being adapted to a composition of the gas turbine component.

37. The method as recited in claim 36 wherein the component is a gas turbine blade.

38. The method as recited in claim 20 wherein the stripping includes removing a coating of titanium nitride (TiN) or of titanium aluminium nitride (TiAlN) or of titanium zirconium nitride (TiZrN) or of chromium aluminium nitride (CrAlN) or chromium nitride (CrN) from the component, the component being a gas turbine component made of a titanium-based alloy.

39. The method as recited in claim 20 for removing a coating of titanium nitride (TiN) or of titanium aluminium nitride (TiAlN) or of titanium zirconium nitride (TiZrN) or of chromium aluminium nitride (CrAlN) or chromium nitride (CrN) from the component, the component being a gas turbine component made of a nickel-based alloy.

40. An electrode for electrochemically stripping components comprising:
an impression of a component region to be stripped, the impression being formed from a moldable, electrically conductive compound.

41. The electrode as recited in claim 40 wherein the compound is a cured compound.

42. The electrode as recited in claim 40 wherein the impression is based on a gas turbine component.

43. The electrode as recited in claim 40 wherein the electrode is porous, and the moldable, electrically conductive compound is a sintered material.

44. A method for electrochemically stripping components comprising the steps of:
connecting a component to be stripped to one of a positive terminal and negative terminal of a voltage or current source and an electrode to the other of the positive terminal and the negative terminal of the voltage or current source;
positioning the electrode so that a gap between a region of the component to be stripped and the electrode is a same size over an entirety of the region to be stripped, the electrode being adapted to a region of the component to be stripped; and
electrochemically stripping the component.
